(19) United States
(12) Patent Application Publication
(10) Pub. No.: US 2004/0023773 A1
(43) Pub. Date: Feb. 5, 2004

(54) Steel rule cutting die

(76) Inventor: John A. Dombkowski, West Springfield, MA (US)

Correspondence Address: Chester E. Flavin, Ross, Ross & Flavin, 120 Maple Street, Springfield, MA, 01103, US

(21) Appl. No.: 10/207,690

(22) Filed: Jul. 30, 2002

(51) Int. Cl. B26F 1/14

(52) U.S. Cl. 493/340; 83/684

(57) ABSTRACT

A steel rule cutting die having a slotted die backing board fabricated from wood with a laser burned slot therein and a steel rule in the slot, the steel rule having integral projections on its opposite side faces for engaging the walls of the slot, thereby precluding lift out of the steel rule from the slot.

### BACKGROUND OF THE INVENTION

1. Field of the Invention

The invention relates to cutting dies having steel rules for cutting and shaping cardboard and other stock.

2. Description of Related Art

It is standard practice to fit a steel rule into a slot provided in a wood base, the rule being held in the slot by friction or by shims forced into the slot or by other means bearing against the base of the steel rule.

The walls of slots conventionally cut by means of a jig saw are usually rough and provide some degree of holding force when the base of a steel rule is inserted into the slot.

The practice of cutting the slots in the base by means of a jig saw has proven to be time consuming and expensive. Accordingly, the slots are now usually burned into the base by means of a laser, a faster and more economical approach.

However, such laser burned slots are very smooth, so that they offer little or no holding force for gripping a steel rule inserted therein.

Such laser burned slots fall to firmly hold the steel rule in the slot of the base and, in time, the rule eventually lifts out of the slot.

### BRIEF SUMMARY OF THE INVENTION

The invention hereof provides a means for firmly anchoring a steel rule in a laser burned slot in a base. Herein, the upright, opposing, planar faces of the lower portion of a steel rule are knurled or barbed to provide projections which, when the steel rule is inserted in the slot, penetrate the walls of the slot thereby precluding the rule from lifting out of or falling out of the slot.

### BRIEF DESCRIPTION OF THE SEVERAL VEIWS OF THE DRAWINGS

FIG. 1 is a fragmentary plan view of a die backing board having a slot defining a pattern extending into its upper surface for receipt of a steel rule;

FIG. 2 is a fragmentary elevational view of a steel rule embodying a first form of the invention;

FIG. 3 is an enlarged, fragmentary, cross sectional view showing the steel rule of FIG. 2 engaged in the pattern slot of the die backing board of FIG. 1;

FIG. 4 is a fragmentary elevational view of a steel rule embodying a second form of the invention;

FIG. 5 is a fragmentary, elevational view of a steel rule embodying a third form of the invention; and

FIG. 6 is an enlarged, fragmentary, cross sectional view showing the steel rule of FIG. 5 engaged in the pattern slot of a backing board.

### DETAILED DESCRIPTION OF THE INVENTION

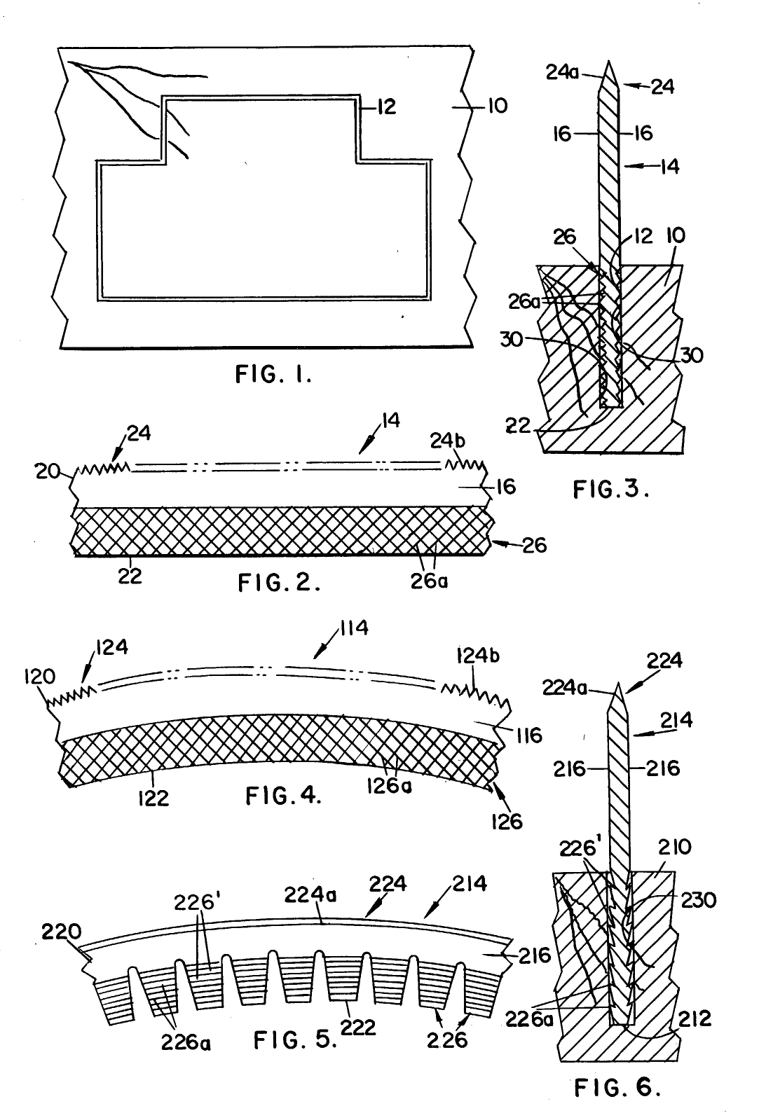

Referring to FIG. 1, a die backing board 10, fabricated from wood, is shown fragmentarily, and has a slot 12 therein which extends downwardly from its upper planar face.

Slot 12 outlines the pattern of an item to be stamped from cardboard or other stock, in known manner, and is burned into the backing board as by a laser.

While backing board 10 is shown to be flat in FIG. 1, it may have a curved profile in end elevation to follow the contour of a drum, not shown, on which it may be mounted, all as is well known in the art.

A steel rule embodying a first form of the invention is shown in FIGS. 2 and 3 and is generally indicated by 14. Rule 14 is inserted into slot 12 of backing board 10 to form a steel rule cutting die.

Steel rule 14 is rectangular in elevation and has opposing, spaced, flat, parallel, upright side walls 16 and spaced, parallel, horizontally-extending upper and lower walls 20 and 22, respectively.

Side walls 16 incline inwardly at their upper ends to form a cutting edge, generally indicated by 26, which may be a knife edge 24a, as shown in FIG. 3, or a saw tooth edge 24b as shown in FIG. 2.

Approximately the lower half of each side wall 16 of steel rule 14 is knurled as at 26 to provide a series of small ribs or projections 26a which extend the length of each side wall.

When steel rule 14 is inserted in slot 12 of backing board 10, and bottom wall 22 of the steel rule is brought into contact with a lower end 28 of the slot, ribs or projections 26a of knurling 26 bite into side walls 30 of slot 12 whereby the steel rule is firmly anchored in the slot to insure against the steel rule lifting out of the slot.

A steel rule embodying a second form of the invention is shown in FIG. 4 and is generally indicated by 114.

Steel rule 114 differs from steel rule 14 of FIGS. 2 and 3 only in that its upper and lower walls 120 and 122 respectively, define a radius to follow the profile of a curved backing board, not shown.

Steel rule 114 has spaced, flat, parallel, upright side walls 116, only one of which is shown in the drawing.

Side walls 116 incline inwardly at their upper ends to form a cutting edge generally indicated by 124, which may be a knife edge, now shown, or a saw tooth edge 124b, as shown in FIG. 4.

Approximately the lower half of each side wall 116 is knurled as at 126 to provide a series of small ridges or ribs 126a which extend the length of steel rule 114.

As with steel rule 14 of the embodiment of FIGS. 2 and 3, when steel rule 114 is inserted in slot 12 of backing board 10, and bottom wall 122 of the steel rule is bought into contact with a lower end 28 of the slot, ridges or ribs 126a of knurling 126 bite into side walls 30 of slot 12 whereby the steel rule is firmly enclosed in the slot to insure against the steel rule lifting out of the slot.

A steel rule 214 embodying a third form of the invention is shown in FIGS. 5 and 6.

Steel rule 214 has opposing spaced, flat, parallel, and upright side walls 216, spaced, curved, parallel, upright side walls 216, and spaced curved, parallel, upper and lower walls 220 and 222 respectively, each of which defines a radius to follow the profile of a curved backing board 210.

Side walls 216 incline inwardly at their upper ends to form a cutting edge, generally indicated by 224, which may have an upper knife edge 224a as shown in FIGS. 5 and 6.

Lower half portion of steel rule 214 is provided with a series of spaced, downwardly-extending, fingers 226.

Fingers 226 are generally triangular in elevation and are truncated at lower ends.

The lower ends of fingers 226 together define lower wall 222 of steel rule 214.

Each side wall 216 of steel rule 214 is provided with a series of spaced parallel inclined grooves 226′ which extend transversely across each finger 226.

Grooves 226′ define a series of spaced, sharply pointed, upwardly directed barbs 226a, best seen in FIG. 6, which extend angularly outwardly from each side wall 216.

When steel rule 214 is inserted in a slot 212 of backing board 210 and bottom wall 222 of the steel rule is brought into contact with a lower end 228 of the slot, barbs 226a of fingers 226 bite into side walls 230 of slot 212, whereby the steel rule is firmly anchored in the slot to insure against the steel rule lifting out of the slot.

I claim:

1. In a steel rule cutting die having a slotted die backing board and a steel rule in the slot of the backing board, the improvement which comprises integral projections on the steel rule, the projections engaging walls of the slot thereby precluding lift out of the steel rule from the slot.

2. In a steel rule cutting die according to claim 1, wherein the projections comprise a series of knurled ribs on opposite side faces of the steel rule.

3. In a steel rule cutting die according to claim 1 wherein the projections comprise a series of barbs on opposite side faces of the steel rule.

4. In a steel rule cutting die according to claim 1, wherein the die backing board is fabricated from wood.

5. In a steel rule cutting die according to claim 1, wherein the die backing board is fabricated from wood and the slot is burned into the die backing board by a laser.
